(19) United States
(12) Patent Application Publication
(10) Pub. No.: US 2005/0126368 A1
(43) Pub. Date: Jun. 16, 2005

(54) Apparatus and method for teaching how to play musical instruments

(76) Inventor: Andrew D. Harrison, Culver City, CA (US)

Correspondence Address: MORGAN & FINNEGAN, L.L.P., 3 World Financial Center, New York, NY, 10281-2101, US

(21) Appl. No.: 11/010,061

(22) Filed: Dec. 10, 2004

Related U.S. Application Data
(60) Provisional application No. 60/528,999, filed on Dec. 11, 2003.

(51) Int. Cl. G09B 15/02

(52) U.S. Cl. 84/471 R

(57) ABSTRACT

An apparatus and method for teaching how to play stringed instruments and keyboard instruments by correlating particular colors to specific scale tones and chord tones. The method of this invention includes providing fingerboard and keyboard charts that display color-coded maps of scales, chords or individual scale or chord tones to assist in learning how to play scales, chords and melodies. Each tone of the scale or chord has a corresponding color that remains correlated with the scale or chord tone throughout different musical keys. The three primary colors (red, blue and yellow, respectively) are used to identify the root, third and fifth chord tones, the three primary tones of a chord.

### FIELD OF THE INVENTION

This invention generally relates to an apparatus and method for teaching how to play musical instruments. More particularly, the present invention is directed to an apparatus and method of teaching musical notes, scales and chords on stringed instruments and keyboard instruments by associating colors with specific scale and chord tones.

### BACKGROUND OF THE INVENTION

There are numerous music teaching methods designed to help students learn how to play the guitar, piano and other stringed and keyboard instruments. Many of these methods do not use color at all. Some of these methods either focus on certain types of chord shapes or on voicings that are used for specific musical genres and do not teach how to play the chords over the entire length of the fingerboard or keyboard.

In some methods, color is used to correlate positions on a fingerboard or keyboard to notes on a musical staff, with a particular color on the fingerboard or keyboard corresponding to a note on the staff. In others, the color coding is used only to designate positions on a representation of a fingerboard or keyboard and is note specific, i.e., “A” will be coded red, “B” will be coded orange, “C” will be coded green, etc. In these methods, the colors used to designate the notes are chosen randomly and have no relation to the letter of the note or the position of the note in a scale or in a chord.

In some teaching methods, the color corresponding to the note is further associated with an image of an item of the same color that is spelled starting with the same letter as the letter of the note, e.g., “A” will be coded “apple red.” In other methods, the color coding relates to the character of the chord tone, i.e., the colors identify the major, minor, diminished and augmented qualifications of the third or fifth of the chord. Similar methods use color to identify the character of a particular chord by applying color to one of the tones of that chord, i.e., the root or third of a major chord is represented by one color, and the root or third of a minor chord is represented by another color. This method teaches students to differentiate between chords of different characters. In these methods, the colors are also chosen randomly and bear no relation to the position of the note in the scale or the chord.

Stringed instruments such as guitar and banjo and keyboard instruments such as piano and accordion allow the music student a means to visualize the arrangement and relationship of notes and scales that is not available with respect to other instruments. Although there are many music teaching methods using color as a visual aid, to date music teaching methods have not taken full advantage of the opportunity afforded by color to visualize the interrelationships between scale tones and chord tones on stringed and keyboard instruments. There remains a need for a music teaching method that uses color to highlight these interrelationships and differentiate between the positions of notes in scales and chords on stringed instruments and keyboard instruments.

### SUMMARY

The present invention provides an apparatus and method for teaching students how to play stringed instruments and keyboard instruments that highlight the interrelationships between scale tones and chord tones by using colors corresponding to specific tones in scales and chords. The general purpose of the present invention is to assist students of stringed instruments and keyboard instruments in learning how to play scales and chords. Color association is used to teach scale tones and chord tones and the interrelationships between the tones. One aspect of the invention includes charts of fingerboards for stringed instruments. Another aspect includes charts of keyboards for keyboard instruments.

In both of these aspects of the invention, the fingerboard and keyboard charts display color-coded positions that correspond to specific scale and chord tones. Each scale tone has a corresponding color that remains correlated with the same scale tone throughout scales and chords of different musical keys. The three primary colors (red, blue and yellow) are used to identify the root, the third and the fifth, the three primary tones of a chord. Green, one of the so-called “additive” primary colors, is used to identify the seventh, the tone most commonly added to the other three tones. This invention includes charts of fingerboards and keyboards that display color-coded maps of scales, chords or individual scale or chord tones to assist students in learning how to play the scales, chords or individual tones on the stringed instrument or keyboard instrument.

This invention allows individuals to visualize the entire fingerboard and keyboard. It allows the student to learn how to play chords along the entire fingerboard and keyboard. This invention also affords an easy way for the student to explore numerous possibilities for chord voicings and inversions and encourages exploration of new voicings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a chart that shows the three primary chord tones and the three primary colors that correspond to these tones;

FIG. 2 is a chart that shows the three primary chord tones and the three primary colors that correspond to these tones, including the lighter shades of blue and yellow that correspond to the minor third tone and the lowered fifth tone, respectively;

FIG. 3 is a chart that shows basic chord construction using the three primary chord tones and the three primary colors that correspond to these tones;

FIG. 4 is a chart that shows which colors correspond to the first, third, fifth and seventh scale tones;

FIG. 5 is a chart that shows which colors correspond to the specific tones of the scale for all tones of the scale

FIG. 6 is a chart of a piano keyboard showing an application of the invention with color-coded piano keys;

FIG. 7 is a chart of a portion of a guitar fingerboard showing an application of the invention with a map of a root C tone and an octave C tone;

FIG. 8 is a chart of a portion of a guitar fingerboard showing an application of the invention with a map of a C major triad and the recommended fingering for the triad;

FIG. 9 is a chart of a portion of a guitar fingerboard showing an application of the invention with a map of a C major chord and the recommended fingering for the chord;

FIG. 10 is a chart of a guitar fingerboard showing a map of all the positions where the root tone C can be played;

FIG. 11 is a chart of a piano keyboard showing a map of all the positions where the root tone C can be played;

FIG. 12 is a chart of a guitar fingerboard showing a map of all the positions where the third tone E can be played;

FIG. 13 is a chart of a guitar fingerboard showing a map of all the positions where the fifth tone G can be played;

FIG. 14 is a chart of a guitar fingerboard showing a map of all the voicings of a C major chord;

FIG. 15 is a chart of a guitar fingerboard showing an application of the invention with a map of the C major scale;

FIG. 16 is a chart of a guitar fingerboard showing a map of all of the voicings of an A# minor 7 chord;

FIG. 17 is a chart that shows the tones of the scales in all keys with the corresponding colors for the scale and chord tones throughout all the musical keys;

### DETAILED DESCRIPTION

This invention relates to an apparatus and method for teaching students how to play stringed instruments and keyboard instruments by correlating particular colors to specific scale tones and chord tones. This method exploits the unique advantage of stringed instruments and keyboard instruments, i.e., that the structure of these instruments allows the student a means to visualize the arrangement and relationships of notes, scales and chords. This invention highlights the interrelationships of scale tones and chord tones and assists students in learning these relationships.

To accomplish this, the fingerboard and keyboard charts of this invention display color-coded positions that correspond to specific scale and chord tones. Each scale tone has a corresponding color that remains correlated with the same scale tone even as other scales and chords from different musical keys are displayed on the charts. The three primary colors (red, blue and yellow) are used to indicate the root tone, the third tone and the fifth tone, because these are the three primary tones of a chord. Green, one of the so-called “additive” primary colors, is used to identify the seventh tone because this is the tone most commonly added to the other three tones.

The root of every scale and chord is red without exception, regardless of which musical key is displayed on the fingerboard or keyboard. The color red was chosen to identify the root tone because the color name begins with same letter as the tone (i.e., “R” for red and “R” for root). The third of every scale and chord is blue without exception, regardless of which musical key is displayed on the fingerboard or keyboard. The color blue was chosen to identify the third tone because musicians consider the “bluesy” note or “blue” note to be a pitch that lies somewhere between the minor and major third of a scale. The fifth of every scale and chord is yellow without exception, regardless of which musical key is displayed on the fingerboard. Yellow was chosen to identify the fifth tone because it is the last of the three primary colors, which are used in this invention to identify the primary tones of a chord. The seventh tone of every scale and chord is green without exception, regardless of which musical key is displayed on the fingerboard. Green was chosen to identify the seventh tone because it is an “additive” primary color, and the seventh is the tone most commonly added to the three primary tones of a chord.

Using these color designations, the fingerboard charts display color-coded maps of scales, chords, individual chord tones, chord progressions or various musical compositions or melodies. The fingerboard charts display color-coded maps of scales spanning the entire fingerboard of the stringed instrument. The fingerboard charts also display color-coded maps of the roots of chords or scales spanning the entire fingerboard of the stringed instrument. The fingerboard charts display color-coded maps of thirds, fifths, sevenths, ninths, elevenths, thirteenths or any other tones of chords or scales spanning the entire fingerboard of the stringed instrument. The fingerboard charts also display chords spanning the entire fingerboard of the stringed instrument. The fingerboard charts display maps of chords or melodies of popular songs or any variety of musical composition.

Keyboard charts use these color designations in the same way to display color-coded maps of scales, chords, individual chord tones and chord progressions or various musical compositions or melodies. The keyboard charts display color-coded maps of scales spanning at least one octave of the keyboard. The keyboard charts also display color-coded maps of the roots of chords or scales spanning at least one octave of the keyboard. The keyboard charts display color-coded maps of thirds, fifths, sevenths, ninths, elevenths, thirteenths or any other tones of chords or scales spanning at least one octave of the keyboard. The keyboard charts also display chords spanning at least one octave of the keyboard. The keyboard charts display maps of chords or melodies of popular songs or any variety of musical composition.

This system can be presented in print format, including books, binders or folders of material or on any variety of electronic format. The material can be organized and indexed by scales, chords, chord progressions and by different ways of tuning a stringed instrument. These indexes will make up a complete library of scales, chords or chord progressions in multiple guitar tunings and various groups of material can be contained on electronic storage media. This system may also include an interactive interface whereby a map of any scale, chord or chord progression can be instantly accessed by the music student. These maps can be printed out in the student's home. There may be a series of electronic storage media geared toward different levels of student sophistication and containing different maps for different types of guitar tuning.

Adverting to the drawings, FIGS. 1 and 2 illustrate which colors correspond to the primary chord tones. The color red corresponds to the root of the chord 102, the color blue corresponds to the third tone of the chord 104, and the color yellow corresponds to the fifth tone of the chord 106. Light blue corresponds to the minor third 202, and light yellow corresponds to the lowered fifth 204.

FIG. 3 is an embodiment of the invention wherein basic chord construction charts illustrate the primary chord tones and corresponding colors. The representation of a major chord 302 shows the red root tone 304, the blue major third tone 306 and the yellow fifth tone 308. FIG. 3 shows the definition of a chord by indicating the number of musical steps between the chord tones 310, 312, 314. The musical steps enumerated here indicate half-steps. The representation of a minor chord 316 shows the red root tone 318, the light blue minor third tone 320 and the yellow fifth tone 322. The representation of a diminished chord 324 shows the red root tone 326, the light blue minor third tone 328 and the light yellow lowered fifth tone 330.

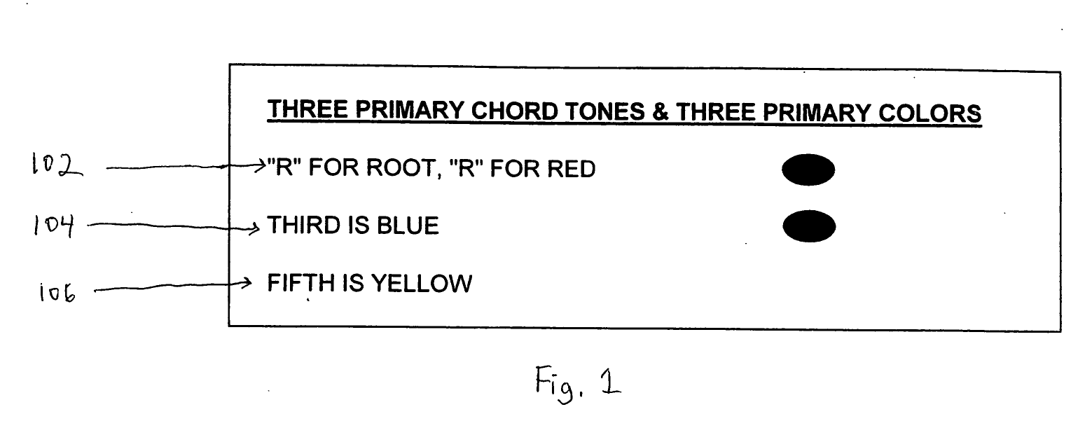

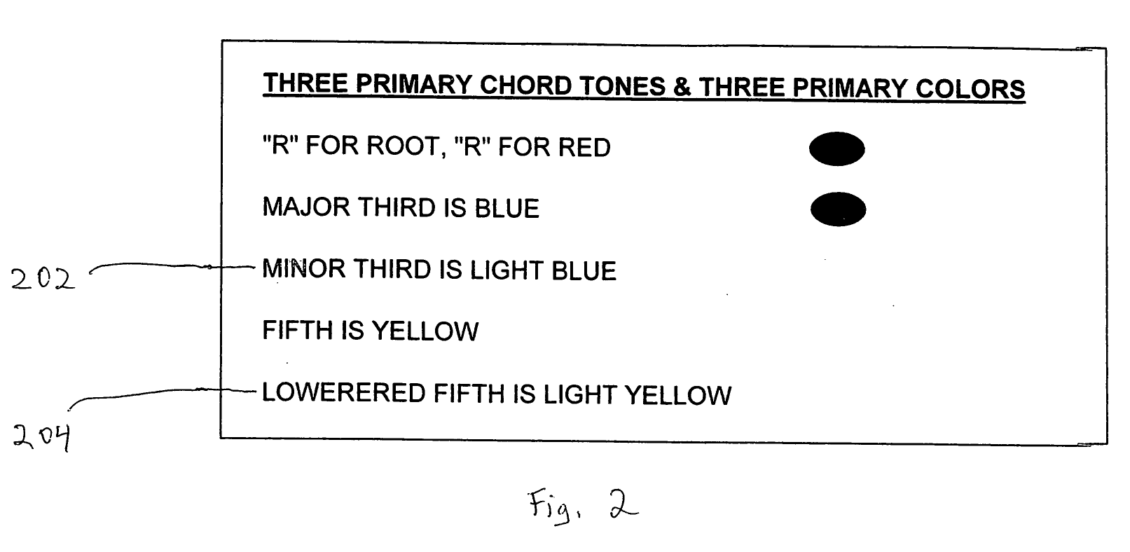

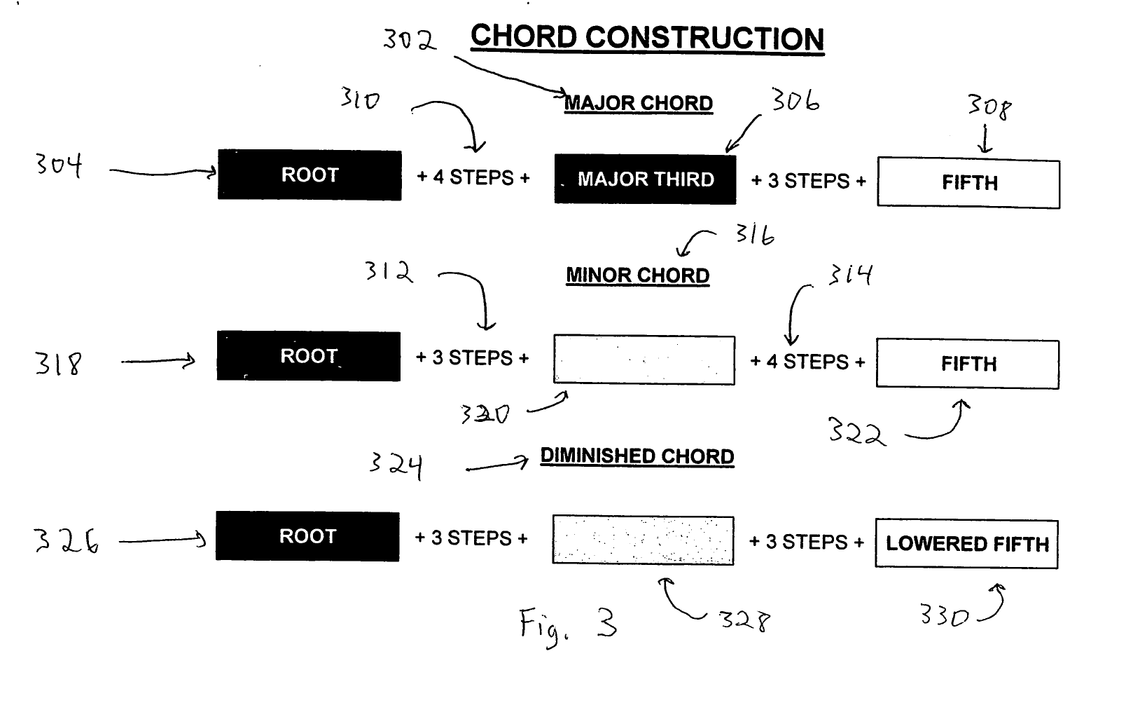

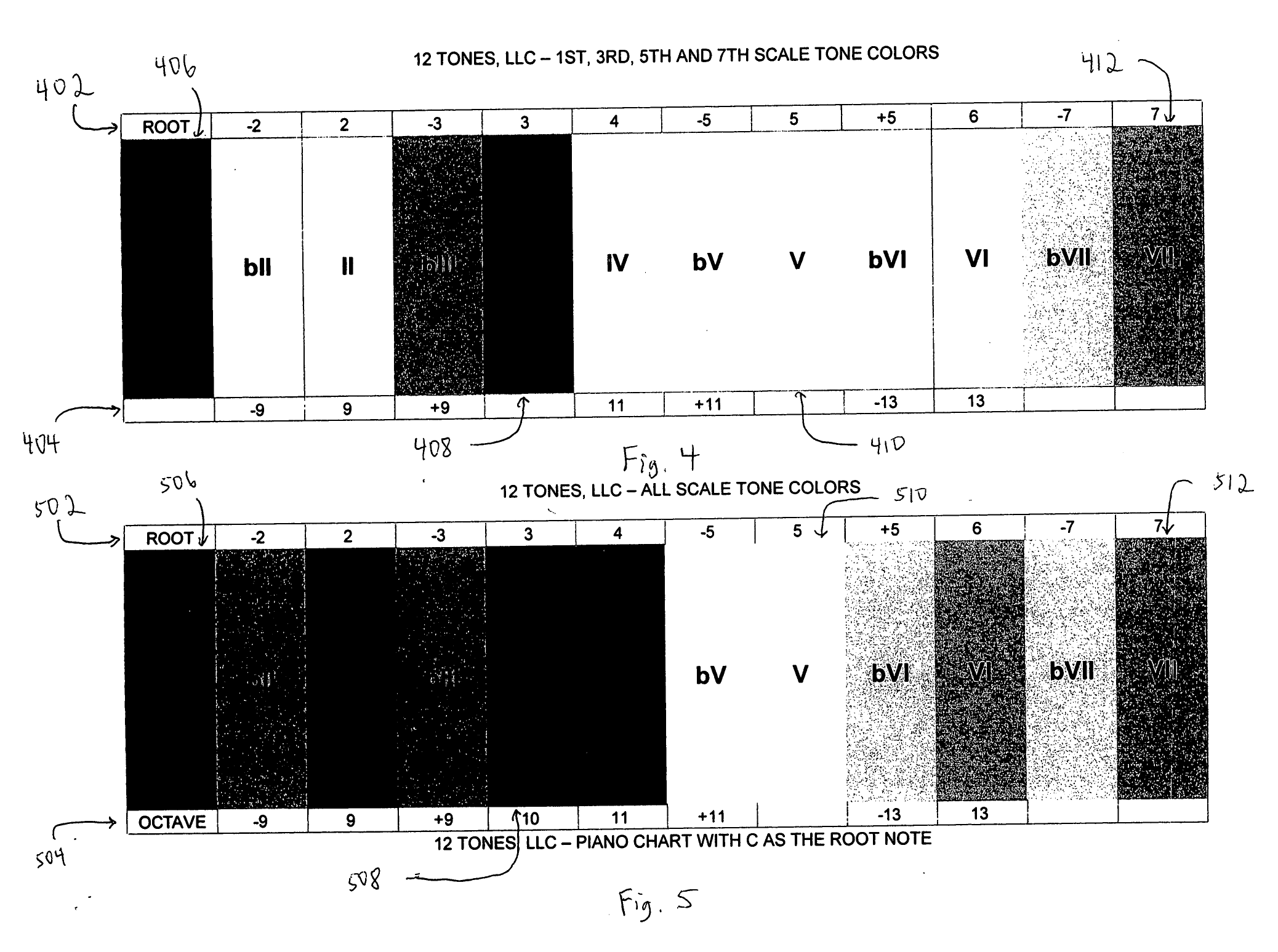

FIGS. 4 and 5 are embodiments of the invention that illustrate which colors correspond to the specific tones of the scale with tone numbers of the first octave 402; 502 and second octave 404, 504 of the scale. The color red 406, 506 corresponds to the root tone of the scale in the first octave 402, 502 and the octave tone of the scale in the second octave 404, 504. The color blue 408, 508 corresponds to the third tone of the scale in the first octave 402, 502 and the tenth tone of the scale in the second octave 404, 504. The color yellow corresponds to the fifth tone 410, 510 of the scale. The color green 412, 512 corresponds to the seventh tone of the scale.

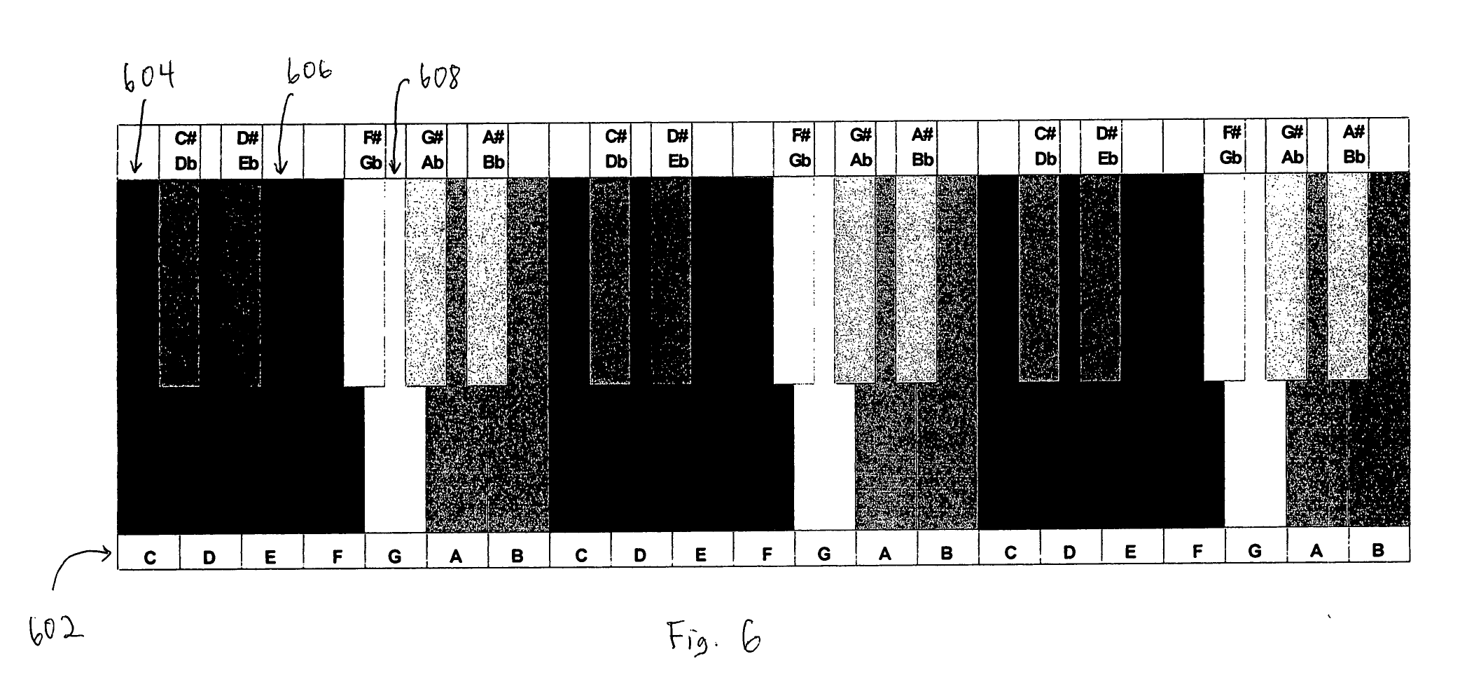

FIG. 6 illustrates an embodiment of the invention wherein a piano keyboard chart identifies which colors correspond to which tones of the scale 602 using C as the root tone. The color red 604 corresponds to the root tone of the scale. The color blue 606 corresponds to the third tone of the scale, in this case the E. The color yellow 608 corresponds to the fifth tone of the scale, in this case the G.

FIG. 7 illustrates an embodiment of the invention wherein a portion of a guitar fingerboard chart 702 identifies the locations of a root C 704 and an octave C 706 on the fingerboard. The accompanying musical staff 708 shows the relationship of the C notes on the fingerboard 704, 706 to the C notes on the staff 710, 712

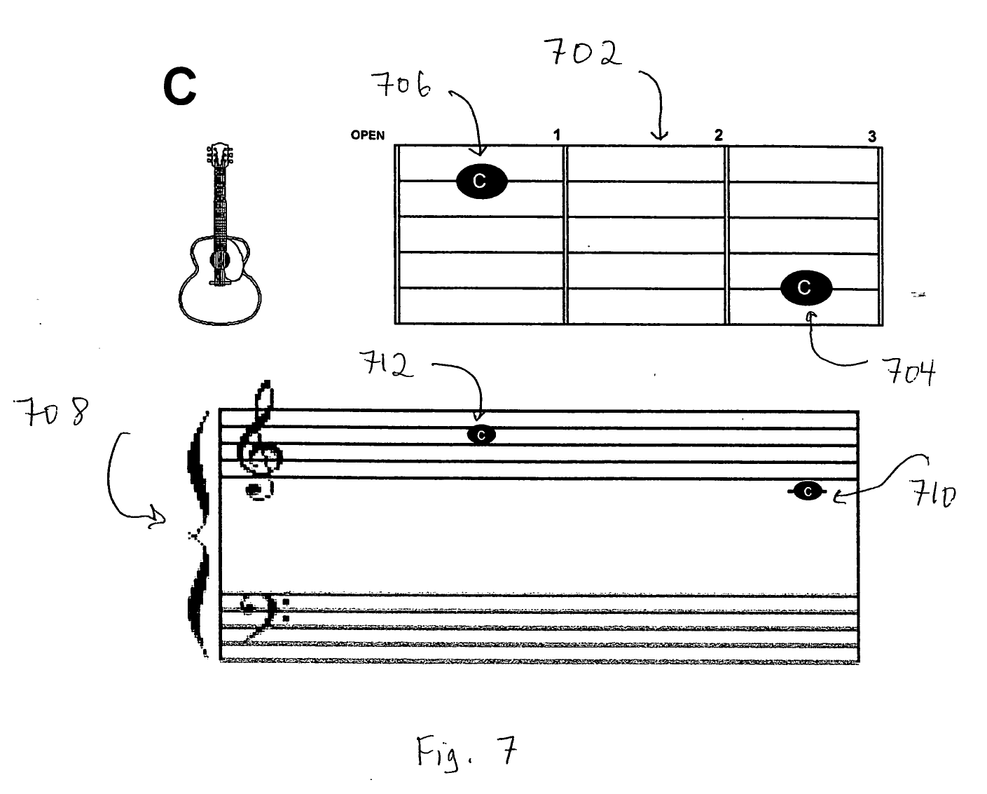

FIG. 8 illustrates an embodiment of the invention wherein a portion of a guitar fingerboard chart 802 identifies the location of a C major triad on the fingerboard. The chart illustrates how to play a C major triad, which contains the notes C 804, E 806 and G 808. The accompanying musical staff 810 shows the relationship of the three tones of the triad on the fingerboard to the three notes of the triad on the staff 812.

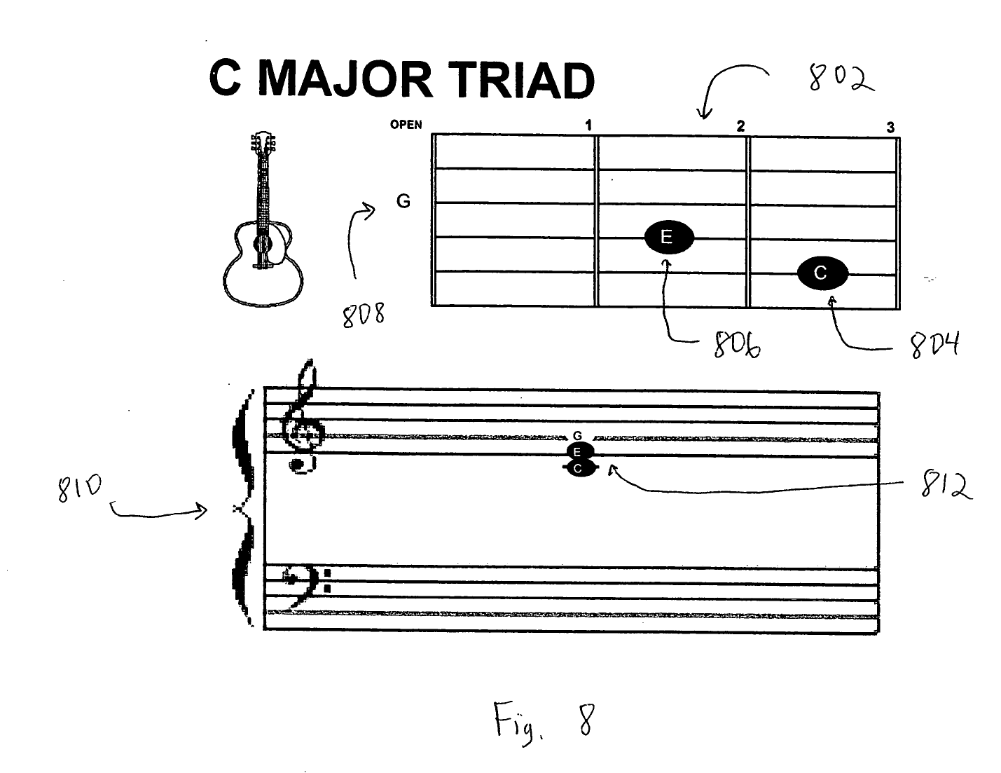

FIG. 9 illustrates an embodiment of the invention wherein a portion of a guitar fingerboard chart 902 identifies the location of a C major chord on the fingerboard. The chart illustrates how to play a C major chord, which contains the notes C 904, E 906, and G 908 and repeats the C 910 and E 912 in a higher octave. The accompanying musical staff 914 shows the relationship of the tones of the chord on the fingerboard to the notes of the chord on the staff 916.

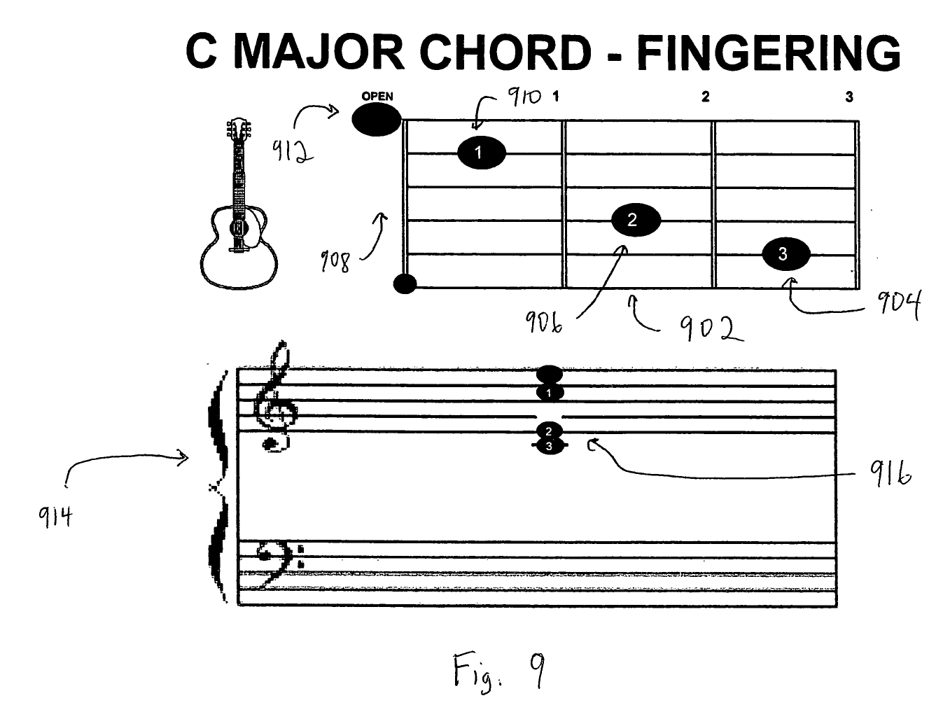

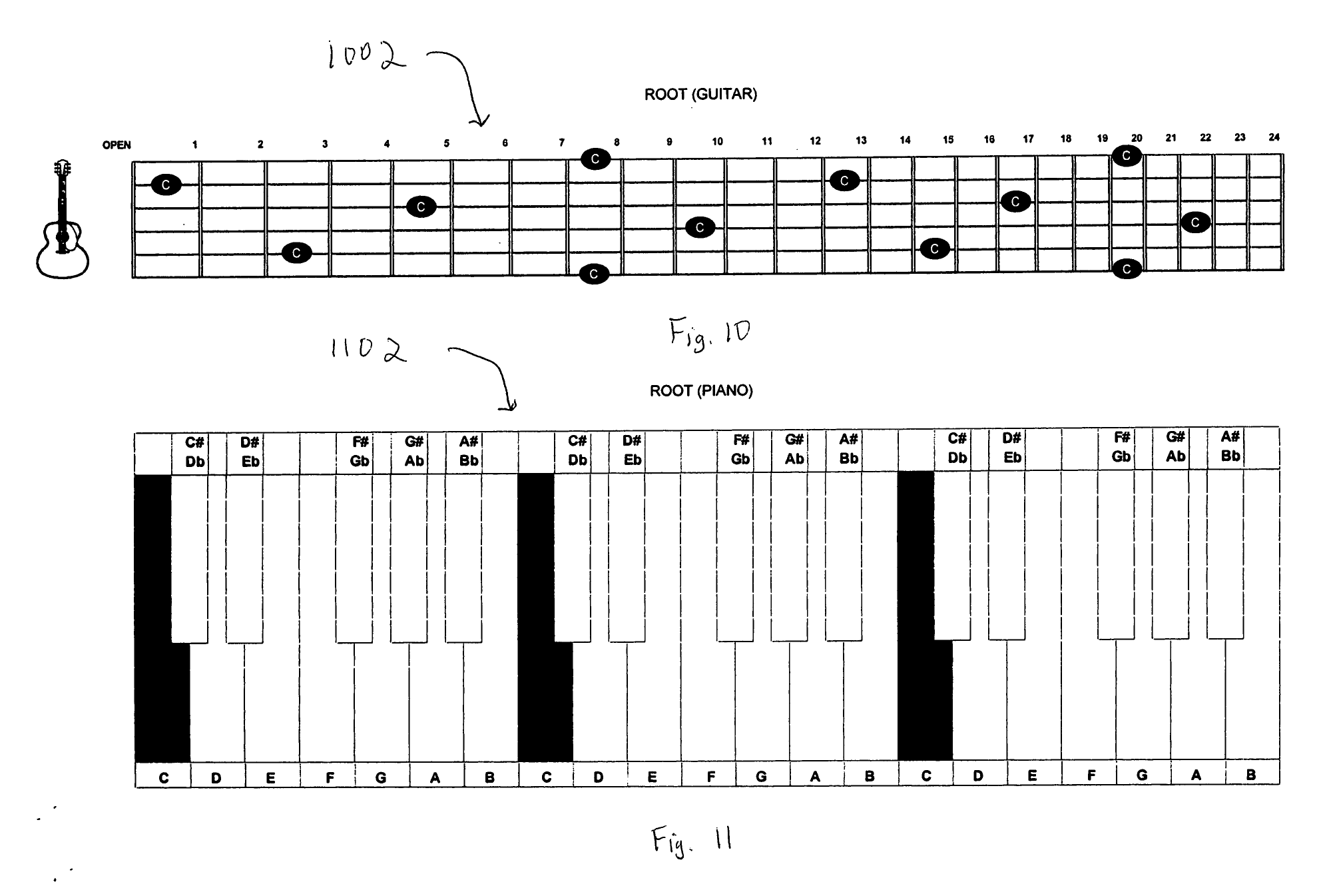

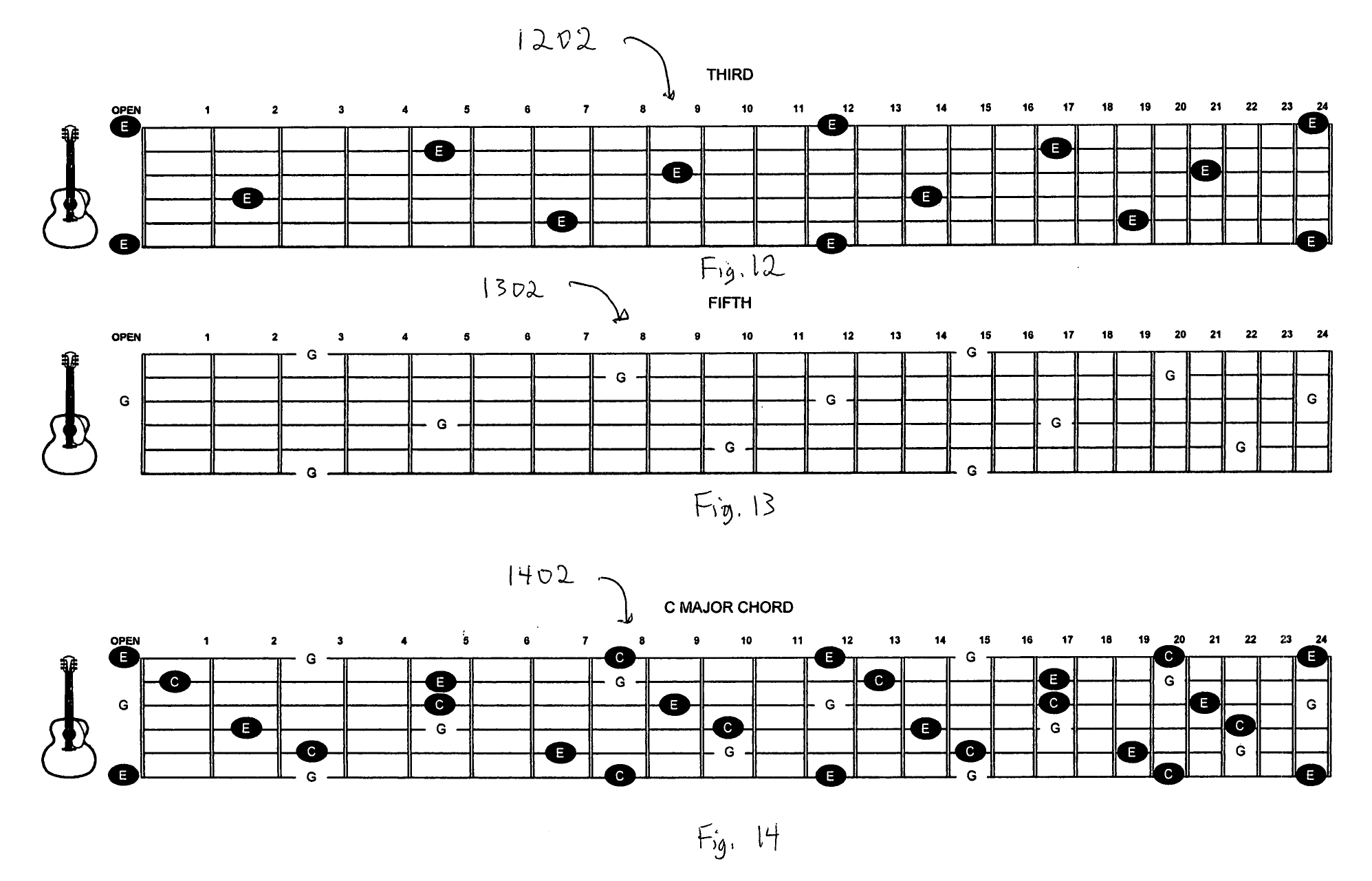

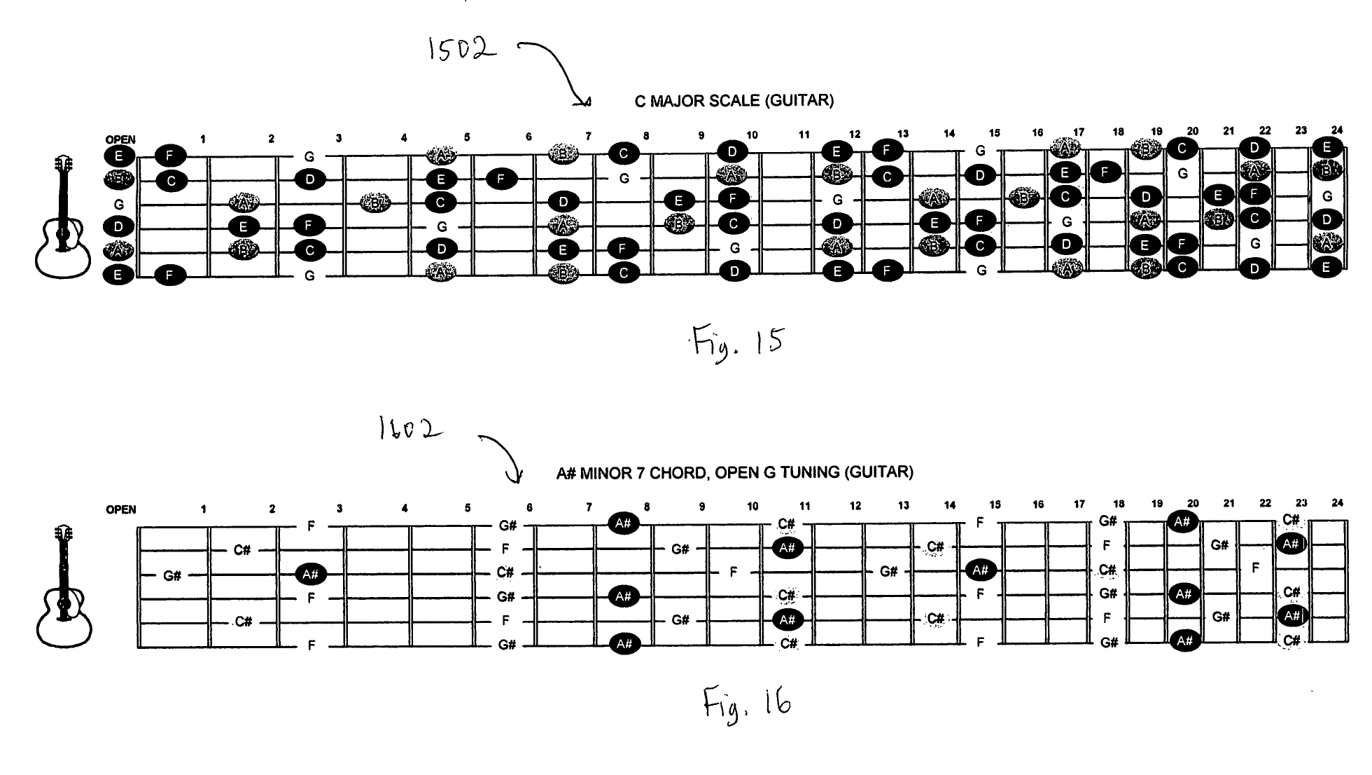

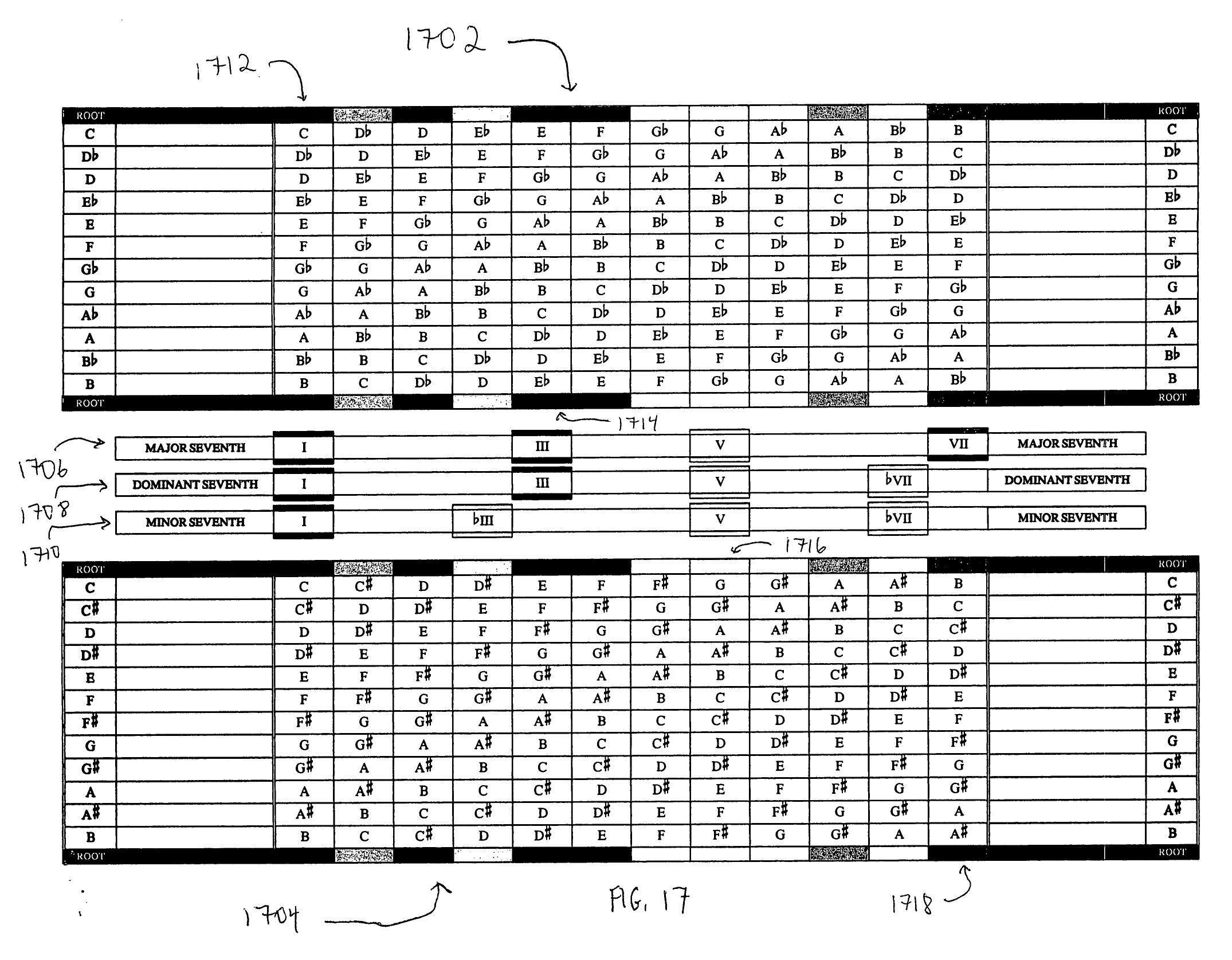

FIG. 10 illustrates an embodiment of the invention wherein a chart of a guitar fingerboard 1002 shows a map of all the positions where the root tone C can be played spanning the entire fingerboard. FIG. 11 illustrates an embodiment of the invention wherein a chart of a piano keyboard 1102 shows all the positions where the root tone C can be played spanning the entire fingerboard. FIG. 12 illustrates an embodiment of the invention wherein a guitar fingerboard chart 1202 shows all the positions where the third tone E can be played spanning the entire fingerboard. FIG. 13 illustrates an embodiment of the invention wherein a guitar fingerboard chart 1302 shows all the positions where the fifth tone G can be played spanning the entire fingerboard. FIG. 14 illustrates an embodiment of the invention wherein a guitar fingerboard chart 1402 shows all the positions where a C major chord can be played spanning the entire fingerboard. FIG. 15 illustrates an embodiment of the invention wherein a guitar fingerboard chart 1502 identifies all of the tones of a C major scale spanning the entire fingerboard. FIG. 16 illustrates an embodiment of the invention wherein a guitar fingerboard chart 1602 identifies all of the positions an A# Minor 7th chord can be played in open G tuning spanning the entire fingerboard.

FIG. 17 illustrates an embodiment of the invention wherein charts show the tones of the scales in all keys with the corresponding colors for the scale and chord tones throughout all the musical keys. One chart shows the colors applied to every musical key using flats to denote half steps 1702. Another chart shows the colors applied to every musical key using sharps to denote half steps 1704. A third chart that lies between the first two charts shows the chord tones for the major seventh chord 1706, the dominant seventh chord 1708 and the minor seventh chord 1710. These charts illustrate that the colors correspond to a particular scale or chord tone, i.e., red for the root tone 1712, blue for the third tone 1714, yellow for the fifth tone 1716, and green for the seventh tone 1718, and remain the same throughout all the musical keys.

Students would use this invention to assist them in learning how to play musical instruments. For example, a student learning how to play scales on the guitar, while holding the guitar, would look at a guitar fingerboard chart such as the chart of the C scale that appears in FIG. 2. The chart simulates the fingerboard of the guitar and shows the positions of the tones of the C major scale. Therefore the student would be able to visualize the corresponding positions on the actual guitar fingerboard and know where to put his or her fingers on the guitar to play the scale tones.

Students would also use this invention to assist them in learning how to play chords. A student learning how to play chords on the guitar, while holding the guitar, would look at a guitar fingerboard chart such as the chart of C major chords that appears in FIG. 6. The chart simulates the fingerboard of the guitar and shows the positions of the tones of the C major chord spanning the entire fingerboard. Specifically, each C is displayed in red, each E in blue and each G in yellow. The student would be able to visualize the corresponding positions on the actual guitar fingerboard and know where to put his or her fingers on the guitar to play the chords. In addition, the colors allow the student to learn chords with different voicings or inversions (i.e., root or third tone as the highest pitch). As a result of this color scheme, a student who wants to voice a chord with the third tone as the highest pitch would simply scan the fingerboard chart until he or she found a display of a chord with the blue note on top and would then play the displayed notes on the fingerboard of the guitar or other stringed instrument to play the chord with that voicing.

Students would also use this invention to learn how to play songs. A student learning to play songs, while holding the guitar, would look at a chart or series of charts that simulates the fingerboard of a guitar and shows the positions of chord progressions or melodies. The student would be able to visualize the corresponding positions on the actual guitar fingerboard and know where to put his or her fingers on the guitar to play the chord progression or melody of the song.

It should be understood that the above description is only representative of illustrative examples of embodiments. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Furthermore, since numerous modifications and variations will readily occur to those skilled in the art, it is not desired that the present invention be limited to the exact construction and operation illustrated. Accordingly, all suitable modifications and equivalents that may be resorted to are intended to fall within the scope of the claims.

1. An apparatus for teaching how to play musical instruments comprising:
a chart for a musical instrument, said chart designating specific colors to specific scale or chord tones and identifying said scale or chord tones by the corresponding colors regardless of musical key.

2. The apparatus of claim 1 wherein said chart is a fingerboard chart for a stringed instrument.

3. The apparatus of claim 2 wherein said stringed instrument is a guitar, bass guitar, violin, cello, contrabass, harp, or any combination thereof.

4. The apparatus of claim 1 wherein said chart is a keyboard chart for a keyboard instrument.

5. The apparatus of claim 1 wherein a root or first tone, a third tone, and a fifth tone of the musical scale or chord displayed are identified by primary colors red, blue and yellow to represent that these tones are primary tones of said chord.

6. The apparatus of claim 1 wherein the root or first tone of the musical scale or chord displayed on the chart is identified by the color red to represent that the words “root” and “red” begin with the letter R.

7. The apparatus of claim 1 wherein the third tone of the musical scale or chord displayed on the chart is identified by the color blue to represent that the third tone has a blues character.

8. The apparatus of claim 1 wherein the fifth tone of the musical scale or chord displayed on the chart is identified by the color yellow.

9. The apparatus of claim 1 wherein a seventh tone of the musical scale or chord displayed is identified by the additive primary color green.

10. The apparatus of claim 1 wherein the chart further comprises a display identifying all of the tones of a musical scale and maps the positions wherein said tones can be played.

11. The apparatus of claim 1 wherein the chart further comprises a display identifying a root tone, a third tone, a fifth tone, a seventh tone, or any other tone or tones of a musical scale or chord, and maps the positions wherein said tone or tones can be played.

12. The apparatus of claim 1 wherein the chart further comprises a display identifying the tones of a musical chord, and maps the positions wherein said chord can be played.

13. The apparatus of claim 1 further comprising a chart identifying a progression of scales.

14. The apparatus of claim 1 further comprising a chart identifying a progression of scale tone or chord tone arpeggios.

15. The apparatus of claim 1 further comprising a chart identifying a progression of chords.

16. The apparatus of claim 1 further comprising a chart identifying partial or complete musical compositions or melodies.

17. The apparatus of claim 1 wherein said charts are organized in a library and contained on electronic storage media.

18. The apparatus of claim 1 wherein said charts are organized in a library and contained in printed material.

19. An apparatus for teaching how to play musical instruments comprising:
a chart for a musical instrument,
said chart having a display of color-coded positions wherein each color corresponds to a specific scale or chord tone and identifies said scale or said chord tone with the corresponding color throughout scales and chords of different musical keys,
said chart further having a display of color-coded positions wherein a root or first tone, a third tone, a fifth tone, of the musical scale or chord are displayed and identified by primary colors red, blue and yellow, respectively, and
said chart further having a display of color-coded positions wherein a seventh tone of the musical scale or chord is displayed and identified by the additive primary color green.

20. The apparatus of claim 19 wherein said chart is a fingerboard chart for a stringed instrument.

21. The apparatus of claim 19 wherein said chart is a keyboard chart for a keyboard instrument.

22. The apparatus of claim 21 wherein said keyboard instrument is a piano.

23. The apparatus of claim 19 wherein the root tone of the scale or chord is identified by the color red to represent that the words “root” and “red” begin with the letter R.

24. The apparatus of claim 19 wherein the third tone of the scale or chord is identified by the color blue to represent that the third tone has a blues character.

25. The apparatus of claim 19 wherein the fifth tone of the scale or chord is identified by the color yellow.

26. The apparatus of claim 19 wherein the chart comprises a display identifying all of the tones of a musical scale and maps the positions of the scale.

27. The apparatus of claim 19 wherein the chart comprises a display identifying the root tone, the third tone, the fifth tone, or any other tone or tones of a scale or chord, and maps the positions wherein said tone or tones can be played.

28. The apparatus of claim 19 wherein the chart comprises a display identifying the tones of a chord, and maps the positions wherein said chord can be played.

29. The apparatus of claim 19 further comprising a chart identifying a progression of scales.

30. The apparatus of claim 19 further comprising a chart identifying a progression of scale tone or chord tone arpeggios.

31. The apparatus of claim 19 further comprising a chart identifying a progression of chords.

32. The apparatus of claim 19 further comprising a chart identifying partial or complete musical compositions or melodies.

33. The apparatus of claim 19 wherein said charts are organized in a library and contained on electronic storage media.

34. The apparatus of claim 19 wherein said charts are organized in a library and contained in printed material.

35. An apparatus for teaching how to play musical instruments comprising:
a fingerboard chart for a stringed instrument,
said fingerboard chart having a display of color-coded positions wherein each color corresponds to a specific scale or chord tone and identifies said scale or said chord tone with the corresponding color throughout scales and chords from different musical keys,
said fingerboard chart further having a display of color-coded positions wherein the root or first tone of the musical scale or chord displayed is identified by the color red to represent that the words “root” and “red” begin with the letter R, the third tone of the musical scale or chord displayed is identified by the color blue to represent that the third tone has a blues character, the fifth tone of the musical scale or chord displayed is identified by the color yellow, and the seventh tone is identified by the additive color green,
said fingerboard chart further comprising displays identifying the tones of musical scales or chords and mapping the positions wherein the scales and chords can be played spanning the entire length of the fingerboard, and
said fingerboard chart further comprising displays identifying a progression of scales or chords or musical compositions or melodies.

36. A method of teaching how to play musical instruments comprising:
providing a chart for a musical instrument,
designating specific colors to specific scale or chord tones on said chart and identifying said scale or chord tones on said chart by the corresponding colors regardless of musical key.

37. The method of claim 36 wherein said chart is a fingerboard chart for a stringed instrument.

38. The method of claim 36 wherein said chart is a keyboard chart for a keyboard instrument.

39. A method of teaching how to play musical instruments comprising:
providing a chart for a musical instrument,
displaying color-coded positions on said chart wherein each color corresponds to a specific scale or chord tone and identifies that scale or chord tone with the corresponding color throughout scales and chords from different musical keys,
further displaying on said chart a root or first tone, a third tone, and a fifth tone of the musical scale or chord identified by primary colors red, blue and yellow to represent that these tones are primary tones of said chord, and
further displaying on said chart a seventh tone identified by the additive primary color green.

40. The method of claim 39 wherein said chart is a fingerboard chart for a stringed instrument.

41. The method of claim 40 wherein said stringed instrument is a guitar.

42. The method of claim 39 wherein said chart is a keyboard chart for a keyboard instrument.

43. The method of claim 39 wherein the root or first tone of the musical scale or chord displayed on the chart is identified by the color red to represent that the words “root” and “red” begin with the letter R.

44. The method of claim 39 wherein the third tone of the musical scale or chord displayed on the chart is represented by the color blue to represent that the third tone has a blues character.

45. The method of claim 39 wherein the fifth tone of the musical scale or chord displayed on the chart is represented by the color yellow.

46. The method of claim 39 comprising displaying on said chart all of the tones of a musical scale and mapping on said chart the positions of the scale.

47. The method of claim 39 comprising displaying on said chart the root tone, the third tone, the fifth tone, or any other tone or tones of a musical scale or chord and mapping on said chart the positions wherein said tone or tones can be played.

48. The method of claim 39 comprising displaying on said chart the tones of a musical chord, and mapping on said chart the positions wherein said chord can be played.

49. The method of claim 39 further comprising displaying a progression of scales to be played on a chart.

50. The method of claim 39 further comprising displaying a progression of scale tone or chord tone arpeggios on a chart.

51. The method of claim 39 further comprising displaying a progression of chords on a chart.

52. The method of claim 39 further comprising displaying partial or complete musical compositions or melodies on a chart.

53. The method of claim 39 wherein said charts are organized in a library and contained on electronic storage media.

54. The method of claim 39 wherein said charts are organized in a library and are contained in printed material.

55. A method for teaching how to play musical instruments comprising:
providing a fingerboard chart for a stringed instrument,
displaying color-coded positions on said fingerboard chart wherein each color corresponds to a specific scale or chord tone and identifies said scale or said chord tone with the corresponding color throughout scales and chords from different musical keys,
further displaying color-coded positions wherein the root or first tone of the musical scale or chord displayed is identified by the color red to represent that the words “root” and “red” begin with the letter R, the third tone of the musical scale or chord displayed is identified by the color blue to represent that the third tone has a blues character, the fifth tone of the musical scale or chord displayed is identified by the color yellow, and the seventh tone of the musical scale or chord displayed is identified by the additive primary color green,
identifying the tones of musical scales or chords on said fingerboard chart and mapping the positions wherein the scales and chords can be played spanning the entire length of the fingerboard, and
further identifying a progression of scales or chords or musical compositions or melodies on said chart.

56. The method of claim 44 wherein the blue note is between a minor and major third tone.
